(19) United States
(12) Patent Application Publication
(10) Pub. No.: US 2024/0147212 A1
(43) Pub. Date: May 2, 2024

(54) TELECOMMUNICATIONS SYSTEM ON A WORK VEHICLE WITH AUTOMATED SIM SELECTION CONTROLLER

(71) Applicant: Deere & Company, Moline, IL (US)

(72) Inventors: Carlos D. HALMANN, Sao Paulo (BR); Bradford A. COX, II, Waukee, IA (US); Gregory J. BARTON, Des Moines, IA (US); Drew M. VANDELUNE, Johnston, IA (US)

(21) Appl. No.: 18/051,376

(22) Filed: Oct. 31, 2022

(51) Int. Cl. H04W 8/18

(52) U.S. Cl. CPC H04W 8/18

(57) ABSTRACT

A telecommunication device on a work vehicle includes a plurality of subscriber identification module (SIM) components and a modem. A SIM selection system connects one of the SIM components to the modem so the telecommunication device can communicate over a cellular communication network. The SIM selection system detects SIM selection criteria and selects the SIM component for connection to the modem based upon the SIM selection criteria.

The present description relates to work vehicles. More specifically, the present description relates to an automatic subscriber identification module (SIM) controller in a telecommunications system on a work vehicle. Hereinafter, the term SIM and SIM card can include both subscriber identification module (SIM) or embedded subscriber identification module (eSIM).

### BACKGROUND

There are a wide variety of different work vehicles. Such vehicles may include construction vehicles, agricultural vehicles, forestry vehicles, turf management vehicles (such as mowers, etc.), and attached or towed implements, among others. Some such vehicles also have a telematics device or telecommunication device (hereinafter collectively referred to as a telecommunication device) that communicates data over cellular communication networks.

In order to gain access to different cellular networks, the telecommunication device includes multiple different SIM cards. The SIM cards contain unique information that identifies the SIM card to a specific mobile or cellular network. The SIM card allows subscribers to receive calls, send messages, or connect to cellular Internet services, among other things.

There are geographic regions where there are multiple different cellular network carriers that provide access to the cellular network and there are geographic areas where only a single carrier is available. To access the cellular network using multiple different carriers, a telecommunication device needs multiple different SIM cards. Some devices include multiple SIM cards and multiple modems so there is an active modem corresponding to each SIM card.

The discussion above is merely provided for general background information and is not intended to be used as an aid in determining the scope of the claimed subject matter.

### SUMMARY

A telecommunication device on a work vehicle includes a plurality of subscriber identification module (SIM) components and a modem. A SIM selection system connects one of the SIM components to the modem so the telecommunication device can communicate over a cellular communication network. The SIM selection system detects SIM selection criteria and selects the SIM component for connection to the modem based upon the SIM selection criteria.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a work vehicle architecture.

FIG. 2 is a block diagram showing one example of a SIM selection system.

FIG. 3 is a flow diagram illustrating one example of the operation of a work vehicle in the architecture illustrated in FIG. 1.

FIG. 4 is a flow diagram illustrating one example of the operation of a SIM selection system in performing time-based SIM selection.

FIG. 5 is a flow diagram illustrating one example of the operation of a SIM selection system in performing location-based SIM selection.

FIG. 6 is a block diagram showing one example of the architecture illustrated in FIG. 1, deployed in a remote server architecture.

FIG. 7 is a block diagram of one example of a computing environment that can be used in the architectures and systems in the previous figures.

### DETAILED DESCRIPTION

As discussed above, there are geographic regions where only a single cellular carrier provides service. Therefore, as a work vehicle with a telecommunication device moves from one region to another region, where a different cellular carrier provides service, the telecommunication device must switch to a different SIM card, in order to perform cellular communication. Telecommunication devices often include only a single active modem, which may connect the telecommunication device to a cellular network through one of a plurality of different SIM cards.

The present description thus describes a system in which a telecommunication device on a work vehicle (which can be a self-propelled vehicle, a towed implement, an attachment, etc.) includes a plurality of SIM components (e.g., embedded eSIM using an embedded universal integrated circuit card eUICC, SIM cards, or plastic SIM cards). The telecommunication device includes a modem and a SIM selection system that selects one of the SIM components to be used by the modem in communicating over a cellular communication network. The SIM selection system detects SIM selection criteria, such as time-based criteria, location-based criteria, coverage availability, signal strength, operator input criteria, or other SIM selection criteria, and selects a SIM component that is to be used by the modem based on the SIM selection criteria. The SIM selection component automatically selects different SIM components as the SIM selection criteria change. By automatically, it is meant that the function or operation is performed without further human involvement, except, perhaps, to initiate or authorize the function or operation. It will be noted that the SIM selection can be performed by selecting an eSIM and requesting an eSIM orchestrator to select a desired SIM profile or controlling selection of the desired SIM profile.

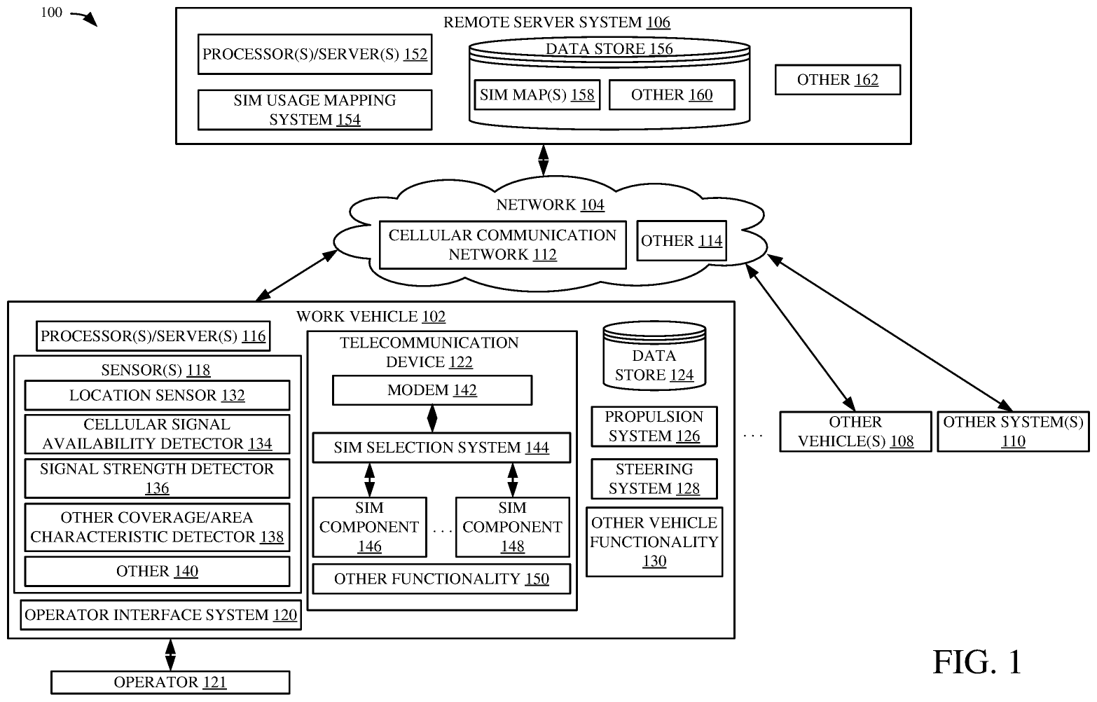

FIG. 1 is a block diagram of one example of a work vehicle architecture 100 in which a work vehicle 102 may communicate over a network 104 with a remote server system 106 and/or with one or more other vehicles 108 and/or other systems 110. Other vehicles 108 can be similar to work vehicle 102 or different. Other systems 110 can be vendor systems, manager systems, mapping or other computing systems, or still other systems. Network 104 can include a cellular communication network 112 and other items 114. Communication over the cellular communication network 112 can be facilitated by different cellular communication carriers. In one example, there may be geographic regions where only a single cellular carrier enables communication over cellular communication network 112. In other geographic regions, a different carrier may enable communication over cellular communication network 112. In still other geographic regions, multiple carriers may enable communication over cellular communication network 112.

Work vehicle 102 may be an agricultural vehicle, a construction vehicle, a forestry vehicle, a turf management vehicle (such as a mower or other turf management vehicle), or another vehicle. In the example shown in FIG. 1, work vehicle 102 includes one or more processors or servers 116, sensors 118, operator interface system 120, telecommunication device 122, data store 124, propulsion system 126, steering system 128, and other vehicle functionality 130. Sensors 118 may include location sensor 132, cellular signal availability detector 134, signal strength detector 136, other coverage/area characteristic detector 138, and other items 140. Telecommunication device 122 can include modem 142, SIM selection system 144, SIM components 146-148, and other communication functionality 150. Remote server system 106 can include one or more processors or servers 152, SIM usage mapping system 154, data store 156 (which may include SIM maps 158 and other items 160), and other functionality 162. Before describing the overall operation of architecture 100, a description of some of the items in architecture 100, and their operation, will first be provided.

Sensors 118 can sense a wide variety of different types of characteristics and generate signals responsive to those characteristics. Location sensor 132, for instance, can be a global navigation satellite system (GNSS) receiver or another system that provides an output indicative of the location of work vehicle 102 in a global or local coordinate system. Location sensor 132 can be a cellular triangulation system, a dead reckoning system, or another system or sensor as well. Cellular signal availability detector 134 detects the availably of cellular carrier signals from different cellular carriers that enable communication over cellular communication network 112. Signal strength detector 136 detects a strength of the cellular signals available from those carriers in decibel-milliwatts (dBm) or other units. Detectors 134 and/or 136 can be applications, circuits, or other detectors. Other coverage/area characteristic detector 138 can detect any of a wide variety of other coverage or area characteristics or other SIM selection criteria.

Operator interface system 120 can include operator interface mechanisms that can be used to output information to operator 121 and to receive inputs from operator 121. Operator interface system 120 can thus include levers, a steering wheel, joysticks, pedals, linkages, knobs, buttons, a display screen, a microphone and speaker (where speech recognition/synthesis functionality is provided), touch sensitive display devices, and other systems that provide haptic, audio and/or visual outputs to operator 121 and receive inputs from operator 121. Where operator interface system 120 includes a display screen, the display screen may display actuatable mechanisms, such as icons, buttons, links, etc. that can be actuated by operator 121 using a point and click device, a touch gesture, speech inputs, etc. Operator 121 can receive outputs from system and provide inputs in order to control and manipulate work vehicle 102 and some other items in architecture 100.

Telecommunication device 122 enables work vehicle 102 to communicate over cellular communication network 112. Telecommunication device 122 can automatically communicate over network 112, such as by sending sensor signal values from sensors 118, or information responsive to those values (such as information derived from those values or based on those values) to other systems over cellular communication network 112. Telecommunication device 122 include a plurality of different SIM components 146-148 that each allow telecommunication device 122 to communicate over cellular communication network 112 using a different carrier. In one example, shown in FIG. 1, telecommunication device 122 includes only a single active modem 142. Therefore, SIM selection system 144 receives SIM selection criteria and, based upon those criteria, connects one of the SIM selection components 146-148 to modem 142.

Data store 124 can store any of a wide variety of information. For instance, data store 124 can store information identifying the SIM selection criteria that are used by SIM selection system 144. Data store 124 can store a SIM selection map so that SIM selection system 144 can receive information from location sensor 132 identifying the location of work vehicle 102 and access the SIM selection map to select a SIM component 146-148 based upon the location of work vehicle 102. Data store 144 can include a wide variety of other information as well.

Propulsion system 126 may include an engine and transmission, or other motors configured to provide propulsion of work vehicle 102. Steering system 122 can include steerable wheels, tracks, or other ground-engaging elements to steer work vehicle 102.

In remote server system 106, SIM usage mapping system 154 can receive information from work vehicle 102 and/or other vehicles 108 indicative of which SIM components 146-148 are selected by SIM selection system 144 at different geographic locations. SIM usage mapping system 154 can then generate one or more SIM maps 158 which identify which SIM components 146-148 should be selected at which geographic locations. The SIM maps 158 can be downloaded by work vehicle 102 so that the maps 158 can be used by SIM selection system 144. SIM usage mapping system 154 can include a learning system that continues to revise the SIM maps 158 based upon information received from vehicles 102 and 108.

Therefore, in one example, as work vehicle 102 travels to different geographic locations, SIM selection system 144 continues to receive SIM selection criteria and automatically select one of the different SIM components 146-148 based upon those SIM selection criteria. The SIM selection criteria may change over time or as work vehicle 102 travels, and thus SIM selection system 144 can automatically select different SIM components 146-148 at different times and/or at different locations.

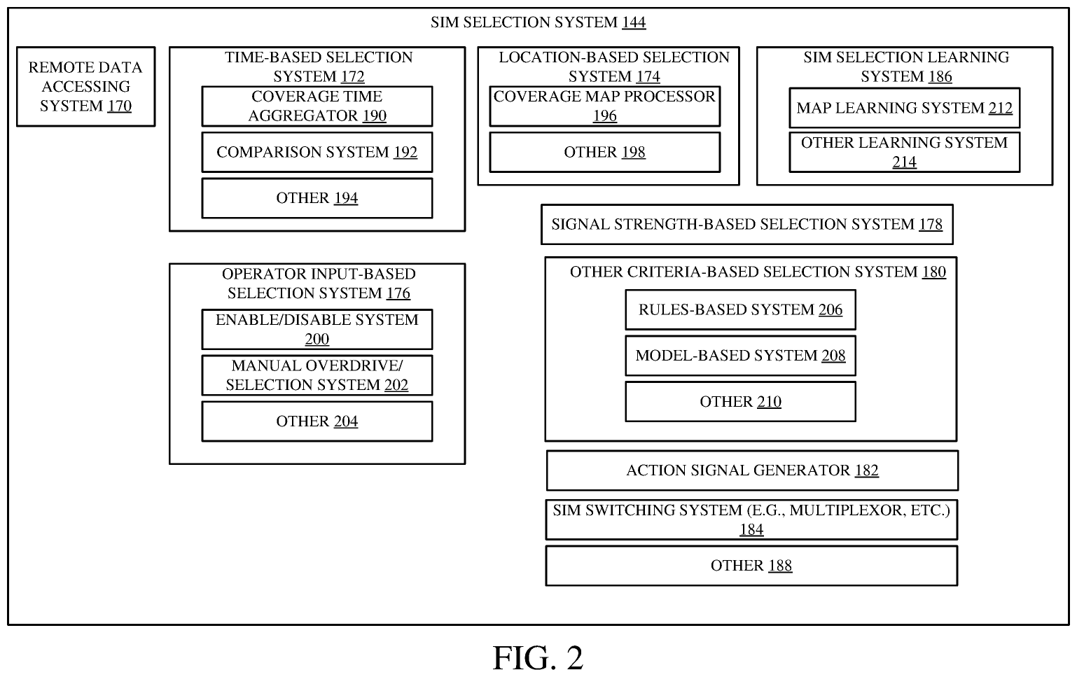

FIG. 2 is a block diagram showing one example of SIM selection system 144 in more detail. In the example shown in FIG. 2, SIM selection system 144 includes remote data accessing system 170, time-based selection system 172, location-based selection system 174, operator input-based selection system 176, signal strength-based selection system 178, other criteria-based selection system 180, action signal generator 182, SIM switching system (e.g., multiplexor) 184, SIM selection learning system 186, and other items 188. Time-based selection system 172 includes coverage time aggregator 190, comparison system 192, and other items 194. Location-based selection system 174 can include coverage map processor 196 and other items 198. Operator input-based selection system 176 can include enable/disable system 200, manual override selection system 202, and other items 204. Other criteria-based selection system 180 can include rules-based system 206, model-based system 208, and other items 210. SIM selection learning system 186 can include map learning system 212 and other learning systems 214.

Remote data accessing system 170 can obtain data from remote sources, such as from remote server system 106, other vehicles 108, other systems 110, etc. Therefore, in one example, remote data accessing system 170 can obtain the identity of the SIM selection criteria that are used by SIM selection system 144, as well as SIM maps 158, and/or other information.

Where the SIM selection criteria are time-based criteria, then time-based selection system 172 obtains and processes the time-based criteria and generates an output indicative of whether the selected SIM component 146-148 should be switched. By way of example, the time-based criteria may include a time threshold. When telecommunication device 122 detects that cellular coverage is unavailable (using the selected SIM component) for a threshold amount of time, then time-based selection system 172 generates an output so SIM selection system 144 selects the other SIM component for use by modem 142. Therefore, in such an example, coverage time aggregator 190 aggregates the time where cellular signal availability detector 134 detects that cellular coverage is unavailable for the currently selected SIM component. Comparison system 192 compares the aggregated time where cellular coverage is unavailable to a threshold time value and generates an output indicating when the aggregated time where cellular coverage is unavailable meets the threshold time. In response, action signal generator 182 can generate an output indicating that SIM switching system 184 should switch to a different SIM component. Thus, assuming that SIM component 146 is the currently selected SIM component, then action signal generator 182 generates an output to SIM switching system 184 indicating the SIM switching system 184 should switch to selecting SIM component 148, instead of SIM component 146.

Where the SIM selection criteria are location-based criteria, then location-based selection system 174 processes the SIM selection criteria and generates an output indicative of which SIM component 146-148 should be selected, or that a switch in SIM components should be made. For instance, coverage map processor 196 receives the current location of work vehicle 102 from location sensor 132 and access a SIM map 158 or coverage map which indicates which SIM component 146-148 should be selected given the current location of work vehicle 102.

Where the SIM selection criteria are signal strength criteria, the signal strength-based system 178 processes those criteria and generates an output indicative of which SIM component 146-148 should be selected. For instance, the SIM component 146-148 corresponding to the greatest detailed signal strength can be selected. In another example a threshold can be used so the selected SIM component is only switched if the signal strength corresponding to the currently selected SIM component is below the signal strength corresponding to a different SIM component by a threshold connection.

Signal strength-based selection system 178 receives an input from signal strength detector 136. Signal strength detector 136 can detect the strength of the cellular signals from one or more different carriers. Based upon the signal strength being sufficient, signal strength-based selection system 178 generates an output to action signal generator 182 indicating that the current signal strength is sufficient so that the currently selected SIM component can continue to be used. Where the signal strength is insufficient (such as compared to a threshold value) then system 178 generates an output to action signal generator 182 indicating that a different SIM component should be selected so that a different carrier, having a greater signal strength, can be used by telecommunication device 122.

In operator input-based selection system 176, enable/disable system 200 may generate an operator input mechanism (such as through a diagnostic display or otherwise) so that operator 121 or another user can provide an input enabling or disabling the automatic selection of a SIM selection component 146-148 by SIM selection system 144. For instance, it may be that operator 121 (or a different user) selects a SIM component 146-148 for use by telecommunication device 122, and the user does not want the SIM selection system 144 to automatically change the SIM component that is selected. This may be, for instance, because the rates offered by a particular carrier are more favorable than the rates offered by other carriers, because the signal provided by one carrier is more reliable than the signals provided by other carriers, or for a wide variety of other reasons.

Manual override/selection system 202 may generate an interface that allows operator 121 or another user to manually select a SIM component 146-148, or to override the automatic selection of a SIM component. In one example, for instance, the manual override/selection system 202 may be accessible through a diagnostic display system, or through another system, so that a desired SIM component 146-148 can be selected and so that automatically changing the selected SIM component can be disabled or overridden.

Other criteria-based selection system 180 can use other criteria to perform automatic SIM component selection. A rules-based system 206 can implement rules or heuristics, based upon SIM selection criteria, in order to select the SIM component. A model-based system 208 may be an artificial neural network, another classifier, or another model-based system that receives the SIM selection criteria as inputs and that generates an output indicative of a desired SIM component that should be selected, or that generates an output indicating the selected SIM component should be switched.

It should also be noted that the output from systems 172, 174, 176, 178, and/or 180 can be combined and used by action signal generator 182 to select a SIM component. For instance, voting logic in action signal generator 182 may receive the input from all of the SIM selection systems 172-180 and generate an output indicating that a particular SIM component 146-148 that was selected by most of the systems 172-180 should be selected, or that a majority of systems 172-180 indicated that a switch in the selected SIM component should be made. The outputs of systems 172-180 can be weighted or combined in other ways as well. Action signal generator 182 can process the outputs of the selection systems 172-180 in other ways as well.

Action signal generator 182 generates an output to SIM switching system 184 indicating that SIM switching system 184 should switch to a different SIM component or to maintain the currently selected SIM component. SIM switching system 184 then connects modem 142 to the selected SIM component 146-148, such as through a multiplexor or other component.

SIM selection learning system 186 can perform learning based upon the output of selection systems 172-180 to generate a model or rules-based system that can be used in selecting a SIM component 146-148. By way of example, map learning system 212 can receive inputs indicative of a current location of vehicle 102 and whether a cellular signal is available from any of a variety of different carriers, as well as the signal strength. Map learning system 212 can learn which SIM component 146-148 should be selected at different geographic locations, given the cellular signal availability and signal strength at those different locations. Other learning systems 214 can perform other machine learning or implement other learning algorithms to learn which SIM component 146-148 should be selected using different criteria.

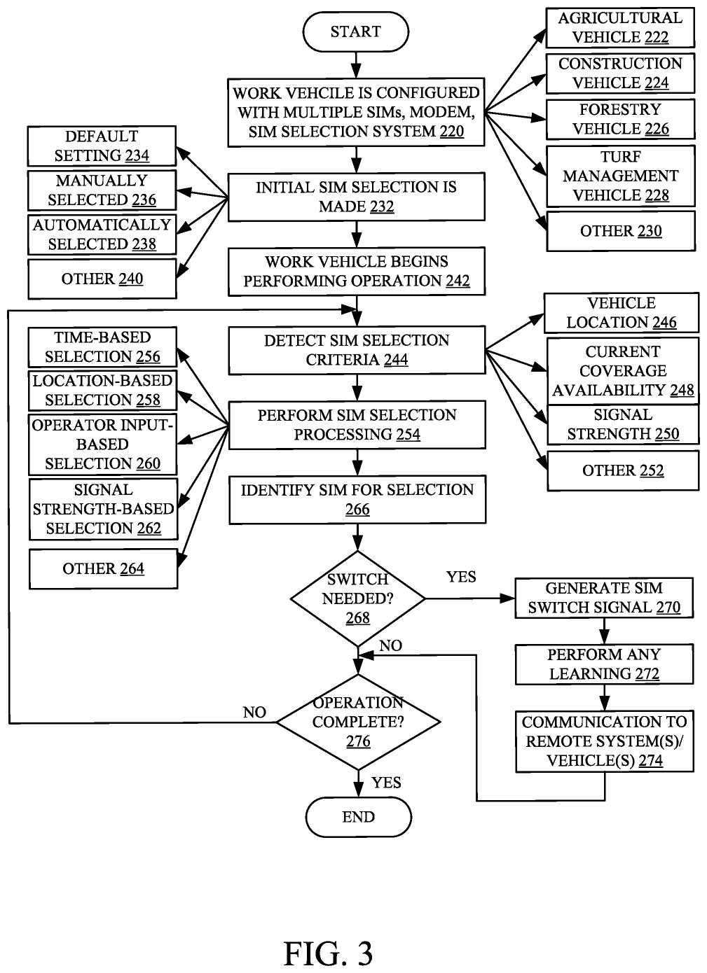

FIG. 3 is a flow diagram illustrating one example the overall operation of work vehicle 102. It is first assumed that work vehicle 102 is configured with multiple SIM components 146-148 and a modem 142 (such as a single modem), as well as a SIM selection system 144. Having work vehicle 102 configured in this way is indicated by block 220 in the flow diagram of FIG. 3. Again, work vehicle 102 can be an agricultural vehicle 222, a construction vehicle 224, a forestry vehicle 226, a turf management vehicle 228, or another work vehicle 230. An initial SIM selection is made to initially select one of SIM components 146-148 for operation with modem 142. The initial SIM selection is indicated by block 232 in the flow diagram of FIG. 3. The initial SIM selection can be based on a default setting 234, a manual SIM selection 236, an automatic SIM selection 238, or another type of initial SIM selection 240.

Work vehicle 102 then begins performing an operation, as indicated by block 242. SIM selection system 144 then detects SIM selection criteria, as indicated by block 244. The SIM selection criteria that are to be used can be identified based on information accessed by remote data accessing system 170 or in other ways. The SIM selection criteria can, for instance, be the vehicle location 246 of vehicle 102 sensed by location sensor 132, the current coverage availability 248 as sensed by availability detector 134, the carrier signal strength 250 as detected by signal strength detector 136, or a wide variety of other criteria 252. SIM selection system 144 then performs SIM selection processing, based upon the detected SIM selection criteria, as indicated by block 254. The SIM selection processing can be time-based selection processing 256 performed by time-based selection system 172. The SIM selection processing can be location-based selection processing 258 performed by location-based selection system 174, or operator input-based selection processing 260 performed by operator input-based selection system 176. The SIM selection processing can be signal strength-based processing 262 performed by signal strength-based selection system 178, or any of a wide variety of other SIM selection processing 264 performed by other criteria-based selection system 180.

Based upon the outputs from one or more of systems 172-180, action signal generator 182 identifies a SIM component 146-148 for selection or indicating that the currently selected SIM component is sufficient or that a switch to a different SIM component 146-148 should be made. as indicated by block 266. If a switch is needed (from the currently selected SIM component to a new SIM component), as indicated by block 268, then SIM switching system 184 generates a SIM switching signal, as indicated by block 270, and SIM learning system 186 performs any desired learning, as indicated by block 272. In addition, action signal generator 182 can control telecommunication device 122 to communicate information indicative of the SIM selection to remote server system 106, to other systems 110, to other vehicles 108, etc., as indicated by block 274. Until operation is complete, as indicated by block 276, processing reverts to block 244 where SIM selection criteria are detected, as work vehicle 102 continues to perform its operation.

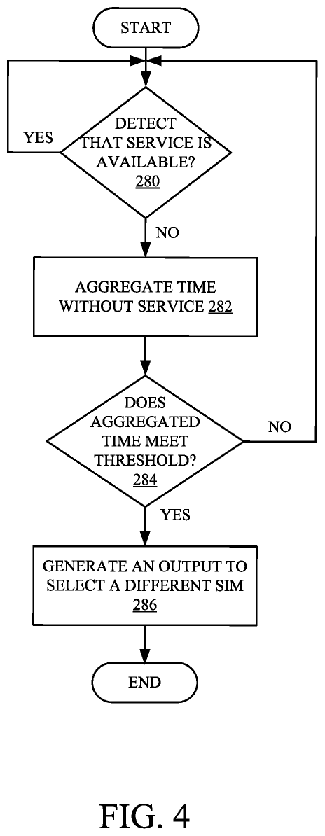

FIG. 4 is a flow diagram illustrating one example of the operation of time-based selection system 172 in selecting a SIM component 146-148 using time-based selection criteria. Coverage time aggregator 190 receives an input from cellular signal availability detector 134 indicative of whether service is currently available for the currently selected SIM component, as indicated by block 280 in the flow diagram of FIG. 4. Once it is determined that a signal is unavailable, then coverage time aggregator 190 begins aggregating the amount of time that vehicle 102 is in an area where coverage is unavailable. Aggregating the time without coverage (e.g., without cellular service) is indicated by block 282 in the flow diagram of FIG. 4.

Comparison system 192 then compares the aggregated time (the continuous time during which work vehicle 102 is without cellular coverage) to a threshold time value, as indicated by block 284. If the aggregated time does not meet the threshold time value, then processing reverts to block 280 where coverage time aggregator 190 continues to determine whether coverage is unavailable and, if so, aggregate time without coverage. However, if, at block 284, it is determined that the aggregated time without coverage meets the threshold value, then comparison system 192 generates an output to select a different SIM component 146-148, as indicated by block 286.

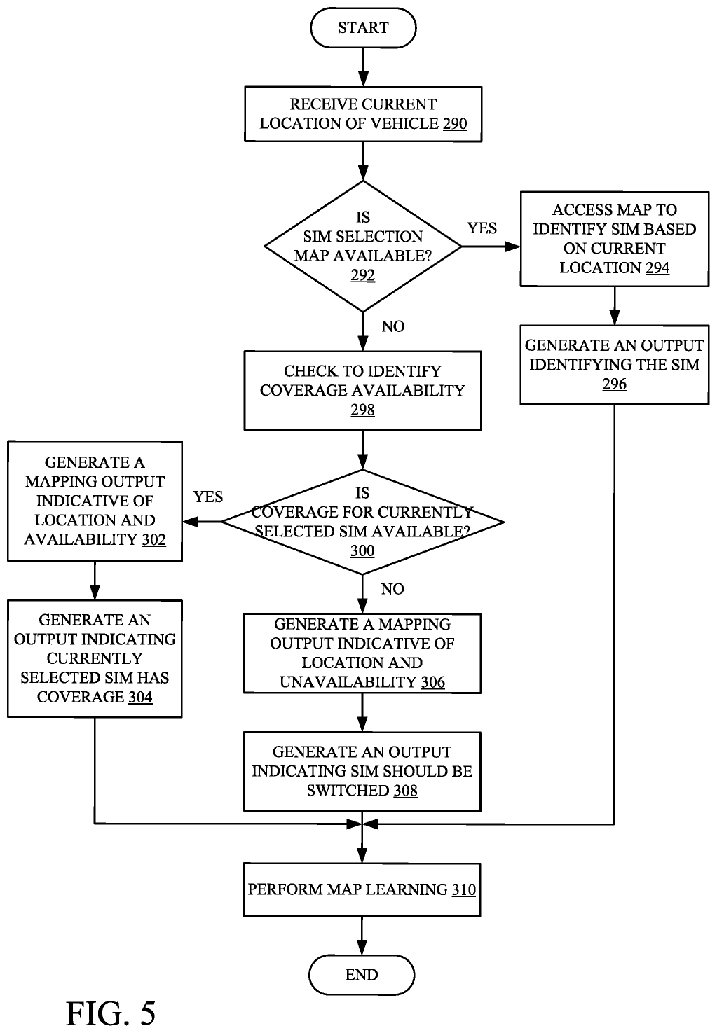

FIG. 5 is a flow diagram illustrating one example of the operation of location-based selection system 174 in more detail. Location-based selection system 174 receives an input from location sensor 132 indicative of a current location of work vehicle 102. Receiving the current location of vehicle 102 is indicated by block 290 in the flow diagram of FIG. 5. If system 172 is using a SIM selection map (such as map 158), as indicated by block 292, then coverage map processor 196 accesses the map to identify the particular SIM component 146-148 that should be selected based upon the current location of vehicle 102, as indicated by block 294. System 174 then generates an output to action signal generator 182 identifying the SIM component 146-148 that should be selected, or identifying that a different SIM selection component should be selected (other than the currently selected SIM component), as indicated by block 296.

If at block 292 it is determined that no map is available, then location-based selection system 174 generates outputs that can be used by map learning system 212 to learn a map that can be used during subsequent operations, or subsequently during the current operation. Therefore, where no map is available, location-based selection system 174 generates outputs indicative of the current location of the work vehicle 102 and whether coverage is available for the currently selected SIM component. Thus, location-based selection system 174 determines whether coverage is available for the currently selected SIM component as indicated by block 300. If so, system 174 generates an output to map learning system 212 identifying the current location and that that cellular coverage is available at this location, as indicated by block 302. Location-based selection system 174 also generates an output to action signal generator 182 indicating that the currently selected SIM component has sufficient coverage so that no switch is needed, as indicated by block 304.

If, at block 300, it is determined that there is no coverage available for the currently selected SIM component, then location-based selection system 174 generates an output to map learning system 212 indicative of the current location of work vehicle 102 and indicating that there is no cellular coverage available for the currently selected SIM component at this location, as indicated by block 306. Location-based selection system 174 also generates an output to action signal generator 182 indicating that the selected SIM component should be switched, as indicated by block 308.

Based upon the outputs from location-based selection system 174, map learning system 212 performs map learning, as indicated by block 310, to learn a SIM selection map. For instance, based upon the various geographic locations and the corresponding availability or unavailability of cellular coverage for a particular SIM component, map learning system 212 can accumulate enough information from work vehicle 102, other vehicles 108, and/or other systems 110 to determine geographic locations where one of the SIM components 146-148 should be selected, and the geographic location where the other SIM component 146-148 should be selected.

It can thus be seen that the present description describes a system on a work vehicle that includes a telecommunication device 122. Multiple SIM components 146-148 are provided with a modem 142 (in one example, telecommunication device 122 has only a single active modem 142) and a SIM selection system 144 detects SIM selection criteria and selects one of the SIM components 146-148 for use by the modem 142. The selection can be made automatically, and learning can also be implemented to improve the performance of the SIM selection system in automatically selecting a SIM component.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which they are displayed is a touch sensitive screen, the mechanisms can be actuated using touch gestures. Also, where the device that displays them has speech recognition components, the mechanisms can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, detectors, generators, and/or logic. It will be appreciated that such systems, components, detectors, generators, and/or logic can be comprised of hardware items (such as processors and associated memory, or other processing components, some of which are described below) that perform the functions associated with those systems, components and/or logic. In addition, the systems, components, detectors, generators, and/or logic can be comprised of software that is loaded into a memory and is subsequently executed by a processor or server, or other computing component, as described below. The systems, components, detectors, generators, and/or logic can also be comprised of different combinations of hardware, software, firmware, etc., some examples of which are described below. These are only some examples of different structures that can be used to form the systems, components, detectors, generators, and/or logic described above. Other structures can be used as well.

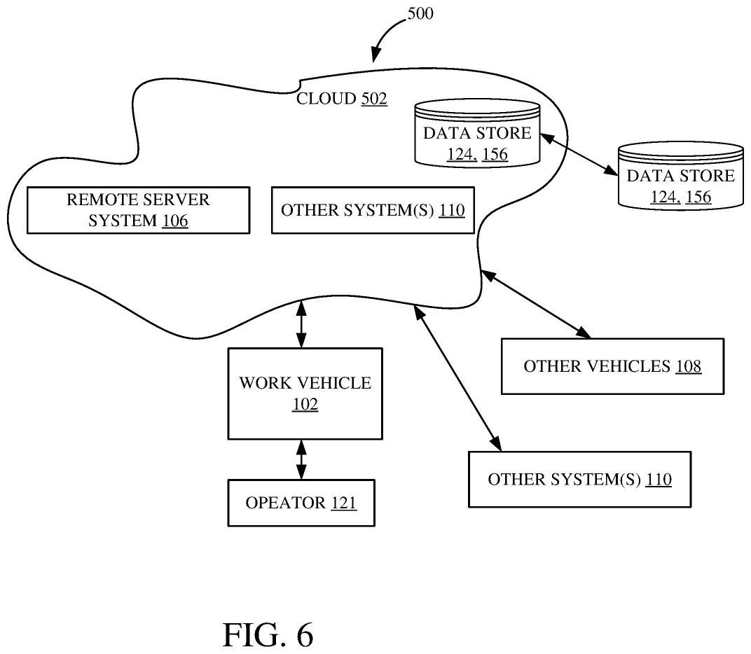

FIG. 6 is a block diagram of the architecture 100, shown in FIG. 1, except that it is disposed in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in FIGS. 1-2 as well as the corresponding data, can be stored on servers at a remote location. The computing resources in a remote server environment can be consolidated at a remote data center location or they can be dispersed. Remote server infrastructures can deliver services through shared data centers, even though the infrastructures appear as a single point of access for the user. Thus, the components and functions described herein can be provided from a remote server at a remote location using a remote server architecture. Alternatively, they can be provided from a conventional server, or the components and functions can be installed on client devices directly, or in other ways.

In the example shown in FIG. 6, some items are similar to those shown in FIG. 1 and they are similarly numbered. FIG. 6 specifically shows that remote server system 106, systems 110 and data stores 124, 156 can be located at a remote server location 502. Therefore, work vehicle 102 accesses those systems through remote server location 502.

FIG. 6 also depicts another example of a remote server architecture. FIG. 6 shows that it is also contemplated that some elements of FIG. 1 are disposed at remote server location while others are not. By way of example, data store 124, 156 or other systems 110 can be disposed at a location separate from location 502, and accessed through the remote server at location 502. Regardless of where the items are located, the items can be accessed directly by work vehicle 102, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. In such an example, where cell coverage is poor or nonexistent, another mobile machine (such as a fuel truck) can have an automated information collection system. As the work vehicle comes close to the fuel truck for fueling, the system automatically collects the information from the work vehicle using any type of ad-hoc wireless connection. The collected information can then be forwarded to the main network as the fuel truck reaches a location where there is cellular coverage (or other wireless coverage). For instance, the fuel truck may enter a covered location when traveling to fuel other machines or when at a main fuel storage location. All of these architectures are contemplated herein. Further, the information can be stored on the work vehicle until the work vehicle enters a covered location. The work vehicle, itself, can then send the information to the main network.

It will also be noted that the elements of FIG. 1, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

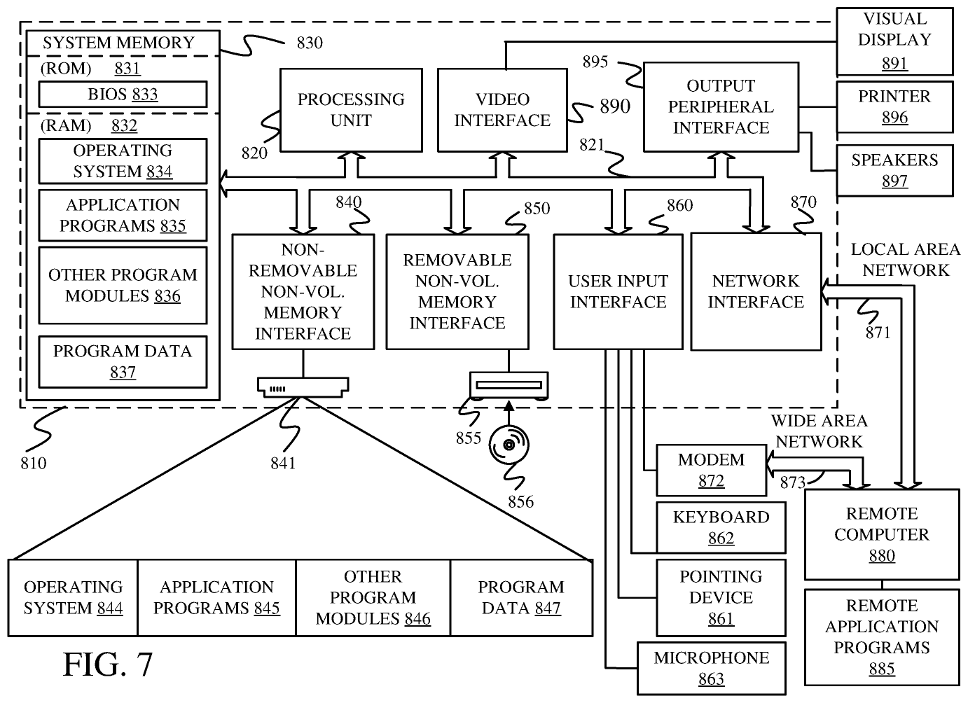

FIG. 7 is one example of a computing environment in which elements of FIG. 1, or parts of it, (for example) can be deployed. With reference to FIG. 7, an example system for implementing some embodiments includes a computing device in the form of a computer 810 programmed to operate as described above. Components of computer 810 may include, but are not limited to, a processing unit 820 (which can comprise processor or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to FIG. 1 can be deployed in corresponding portions of FIG. 7.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 7 illustrates operating system 834, application programs 835, other program modules 836, and program data 837.

The computer 810 may also include other removable/non-removable volatile/nonvolatile computer storage media. By way of example only, FIG. 7 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840 and optical disk drive 855 is typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 7, provide storage of computer readable instructions, data structures, program modules and other data for the computer 810. In FIG. 7, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network—CAN, a local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 7 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A work vehicle, comprising:
a propulsion system;
a steering system;
a set of work functionality; and
a telecommunication system, comprising:
a plurality of subscriber identification module (SIM) components;
a modem; and
a SIM selection system that detects a SIM selection criterion and selects a SIM component, of the plurality of SIM components, as a selected SIM component based on the SIM selection criterion and automatically connects the selected SIM component to the modem.

2. The work vehicle of claim 1 wherein the SIM selection system processes a carrier availability signal indicative of whether cellular service is available at the telecommunication system using the selected SIM component.

3. The work vehicle of claim 2 wherein the SIM selection system comprises:
a time-based selection system that aggregates, as an aggregated time value, a time during which the carrier availability signal indicates that the cellular service is unavailable to the telecommunication system and generates a SIM selection output based on the aggregated time value.

4. The work vehicle of claim 3 wherein the time-based selection system comprises:
a comparison system that compares the aggregated time value to a threshold time value to obtain a comparison result and generates the SIM selection output based on the comparison result.

5. The work vehicle of claim 2 wherein the carrier availability signal is indicative of cellular signal strength.

6. The work vehicle of claim 5 wherein the SIM selection system comprises:
a signal strength-based selection system that generates a SIM selection output based on the cellular signal strength.

7. The work vehicle of claim 1 wherein the SIM selection system comprises:
a location-based selection system that obtains location-based SIM selection criteria and generates a SIM selection output based on the location-based SIM selection criteria.

8. The work vehicle of claim 7 wherein the location-based selection system comprises:
a coverage map processor that receives, as the location-based SIM selection criteria, a location indicator indicative of a geographic location of the work vehicle, accesses a coverage map to identify a SIM component, of the plurality of SIM components, to select based on the geographic location of the work vehicle, and generates a SIM selection output based on the identified SIM component.

9. The work vehicle of claim 1 and further comprising:
a SIM selection learning system configured to receive a learning input indicative of the selected SIM component and the SIM selection criterion and performs learning to generate a modified SIM selection system.

10. A telecommunication system on a work vehicle, comprising:
a plurality of subscriber identification module (SIM) components;
a modem; and
a SIM selection system that detects a SIM selection criterion and selects a SIM component, of the plurality of SIM components, as a selected SIM component based on the SIM selection criterion and automatically connects the selected SIM component to the modem.

11. The telecommunication system of claim 10 wherein the SIM selection system processes a carrier availability signal indicative of whether cellular service is available at the telecommunication system using the selected SIM component.

12. The telecommunication system of claim 11 wherein the SIM selection system comprises:
a time-based selection system that aggregates, as an aggregated time value, a time during which the carrier availability signal indicates that the cellular service is unavailable to the telecommunication system and generates a SIM selection output based on the aggregated time value.

13. The telecommunication system of claim 12 wherein the time-based selection system comprises:
a comparison system that compares the aggregated time value to a threshold time value to obtain a comparison result and generates the SIM selection output based on the comparison result.

14. The telecommunication system of claim 11 wherein the carrier availability signal is indicative of cellular signal strength.

15. The telecommunication system of claim 14 wherein the SIM selection component comprises:
a signal strength-based selection system that generates a SIM selection output based on the cellular signal strength.

16. The telecommunication system of claim 10 wherein the SIM selection system comprises:
a location-based selection system that obtains location-based SIM selection criteria and generates a SIM selection output based on the location-based SIM selection criteria.

17. The telecommunication system of claim 16 wherein the location-based selection system comprises:
a coverage map processor that receives, as the location-based SIM selection criteria, a location indicator indicative of a geographic location of the work vehicle, accesses a coverage map to identify a SIM component, of the plurality of SIM components, to select based on the geographic location of the work vehicle, and generates a SIM selection output based on the identified SIM component.

18. The telecommunication system of claim 10 and further comprising:
a SIM selection learning system configured to receive a learning input indicative of the selected SIM component and the SIM selection criterion and performs learning to generate a modified SIM selection system.

19. A computer implemented method of controlling a telecommunication system on a work vehicle, comprising:
detecting a subscriber identification module (SIM) selection criterion;
selecting a SIM component, of a plurality of SIM components on the telecommunication system, as a selected SIM component based on the SIM selection criterion;
automatically connecting the selected SIM component to a modem; and
performing communication using the selected SIM component.

20. The computer implemented method of claim 19 and further comprising:
performing an operation with the work vehicle;
updating detection of the subscriber identification module (SIM) selection criterion to obtain an updated SIM selection criterion;
automatically updating selection of a SIM component, of the plurality of SIM components on the telecommunication system, as an updated selected SIM component based on the updated SIM selection criterion;
automatically connecting the updated selected SIM component to a modem; and
performing communication using the updated selected SIM component.
